(19) United States
(12) Patent Application Publication
(10) Pub. No.: US 2017/0228225 A1
(43) Pub. Date: Aug. 10, 2017

(54) SYSTEM AND METHOD FOR PRESERVING VALUE AND EXTENDING LIFE OF LEGACY SOFTWARE IN FACE OF PROCESSOR UNAVAILABILITY, RISING PROCESSOR COSTS, OR OTHER ISSUES

(71) Applicant: Honeywell International, Inc., Morris Plains, NJ (US)

(72) Inventor: Elliott Rachlin, Scottsdale, AZ (US)

(21) Appl. No.: 15/017,467

(22) Filed: Feb. 5, 2016

(51) Int. Cl. G06F 9/45; G06F 9/455

(52) U.S. Cl. CPC G06F 8/51; G06F 9/455

(57) ABSTRACT

A method includes obtaining a copy of a first software executed by a first device in an industrial process control and automation system. The method also includes converting the first software to a second software. The second software is configured to perform functions of the first software. A programming language of the second software is different from a programming language of the first software, and the first and second software are designed for use with different operating systems. The method further includes providing the second software to a second device in the industrial process control and automation system for execution.

### TECHNICAL FIELD

This disclosure relates generally to industrial process control and automation systems. More specifically, this disclosure relates to a system and method for preserving the value and extending the life of legacy software in the face of processor unavailability, rising processor costs, or other issues.

### BACKGROUND

Older “legacy” software is often used with components in an industrial process control and automation system. This can be true for many reasons, such as when the sheer number of devices in a process control and automation system makes it difficult or cost-prohibitive to constantly update all of the devices to the latest software versions. However, legacy software may not be compatible with upgraded processors, communication buses, and other hardware components. Due to the high cost and complexity of rewriting legacy software for implementation with upgraded hardware components, installing upgraded hardware components can be cost- and time-prohibitive. This can be undesirable since many users often wish to upgrade their hardware systems in order to obtain the benefits associated with hardware improvements or new hardware products.

### SUMMARY

This disclosure provides a system and method for preserving the value and extending the life of legacy software in the face of processor unavailability, rising processor costs, or other issues.

In a first embodiment, a method includes obtaining a copy of a first software executed by a first device in an industrial process control and automation system. The method also includes converting the first software to a second software. The second software is configured to perform functions of the first software. A programming language of the second software is different from a programming language of the first software, and the first and second software are designed for use with different operating systems. The method further includes providing the second software to a second device in the industrial process control and automation system for execution.

In a second embodiment, an apparatus includes at least one memory configured to store a copy of a first software executed by a first device in an industrial process control and automation system. The apparatus also includes at least one processing device configured to convert the first software to a second software. The second software is configured to perform functions of the first software. A programming language of the second software is different from a programming language of the first software, and the first and second software are designed for use with different operating systems. The apparatus further includes at least one interface configured to provide the second software to a second device in the industrial process control and automation system for execution.

In a third embodiment, a non-transitory computer readable medium contains instructions that, when executed by at least one processing device, cause the at least one processing device to obtain a copy of a first software executed by a first device in an industrial process control and automation system. The medium also contains instructions that, when executed by the at least one processing device, cause the at least one processing device to convert the first software to a second software. The second software is configured to perform functions of the first software. A programming language of the second software is different from a programming language of the first software, and the first and second software are designed for use with different operating systems. The medium further contains instructions that, when executed by the at least one processing device, cause the at least one processing device to provide the second software to a second device in the industrial process control and automation system for execution.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation systems according to this disclosure;

FIG. 2 illustrates an example device for preserving the value and extending the life of legacy software according to this disclosure;

FIG. 3 illustrates an example translation for preserving the value and extending the life of legacy software according to this disclosure;

FIG. 4 illustrates an example conversion architecture to implement a software translation according to this disclosure;

FIG. 5 illustrates an example emulation architecture according to this disclosure; and

FIG. 6 illustrates an example method for preserving the value and extending the life of legacy software according to this disclosure.

### DETAILED DESCRIPTION

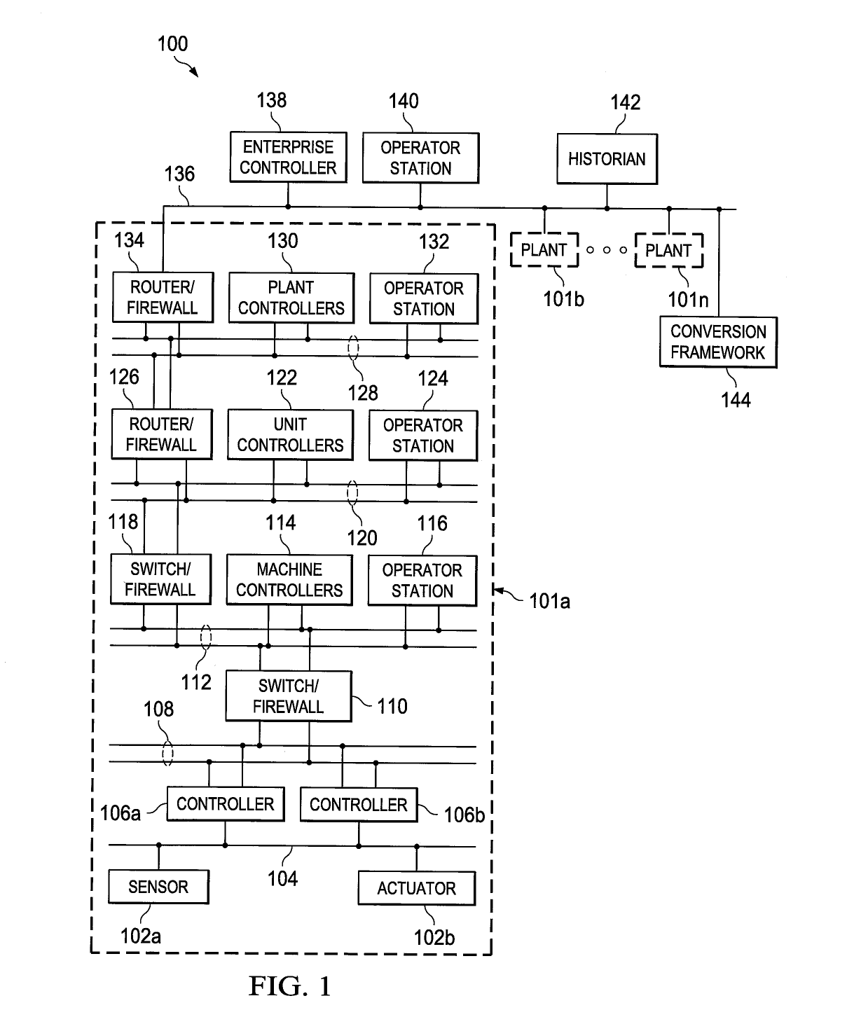

FIGS. 1 through 6, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple industrial plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106a-106b, which are coupled to the network 104. Among other things, each of the controllers 106a-106b may use the measurements from one or more sensors 102a to control the operation of one or more actuators 102b. For example, each controller 106a-106b could receive measurement data from one or more sensors 102a and use the measurement data to generate control signals for one or more actuators 102b. Multiple controllers 106a-106b could also operate in a redundant configuration, such as when one controller 106a operates as a primary controller while another controller 106b operates as a backup controller (which synchronizes with the primary controller and can take over for the primary controller in the event of a fault with the primary controller). Each controller 106a-106b includes any suitable structure for interacting with one or more sensors 102a and controlling one or more actuators 102b. Each controller 106a-106b could, for example, represent a multivariable controller, such as a Robust Multivariable Predictive Control Technology (RMPCT) controller or other type of controller implementing model predictive control (MPC) or other advanced predictive control (APC). As a particular example, each controller 106a-106b could represent a computing device running a real-time operating system.

Two networks 108 are coupled to the controllers 106a-106b. The networks 108 facilitate interaction with the controllers 106a-106b, such as by transporting data to and from the controllers 106a-106b. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106a-106b, sensors 102a, and actuators 102b, which could be associated with a particular piece of industrial equipment (such as a boiler or other machine). For example, the machine-level controllers 114 could log information collected or generated by the controllers 106a-106b, such as measurement data from the sensors 102a or control signals for the actuators 102b. The machine-level controllers 114 could also execute applications that control the operation of the controllers 106a-106b, thereby controlling the operation of the actuators 102b. In addition, the machine-level controllers 114 could provide secure access to the controllers 106a-106b. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Additionally or alternatively, each controller 114 could represent a multivariable controller embedded in a Distributed Control System (DCS), such as a RMPCT controller or other type of controller implementing MPC or other APC. Although not shown, different machine-level controllers 114 could be used to control different pieces of equipment in a process system (where each piece of equipment is associated with one or more controllers 106a-106b, sensors 102a, and actuators 102b).

One or more operator stations 116 are coupled to the networks 112. The operator stations 116 represent computing or communication devices providing user access to the machine-level controllers 114, which could then provide user access to the controllers 106a-106b (and possibly the sensors 102a and actuators 102b). As particular examples, the operator stations 116 could allow users to review the operational history of the sensors 102a and actuators 102b using information collected by the controllers 106a-106b and/or the machine-level controllers 114. The operator stations 116 could also allow the users to adjust the operation of the sensors 102a, actuators 102b, controllers 106a-106b, or machine-level controllers 114. In addition, the operator stations 116 could receive and display warnings, alerts, or other messages or displays generated by the controllers 106a-106b or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one switch/firewall 118 couples the networks 112 to two networks 120. The switch/firewall 118 includes any suitable structure for providing communication between networks, such as a secure switch or combination switch/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Additionally or alternatively, each controller 122 could represent a multivariable controller, such as a HONEYWELL C300 controller. Although not shown, different unit-level controllers 122 could be used to control different units in a process system (where each unit is associated with one or more machine-level controllers 114, controllers 106a-106b, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 142 can be coupled to the network 136. The historian 142 could represent a component that stores various information about the system 100. The historian 142 could, for instance, store information used during production scheduling and optimization. The historian 142 represents any suitable structure for storing and facilitating retrieval of information. Although shown as a single centralized component coupled to the network 136, the historian 142 could be located elsewhere in the system 100, or multiple historians could be distributed in different locations in the system 100.

In particular embodiments, the various controllers and operator stations in FIG. 1 may represent computing devices. For example, each of the controllers and operator stations could include one or more processing devices and one or more memories for storing instructions and data used, generated, or collected by the processing device(s). The instructions and data may comprise a software package for use in operating and controlling MPCs, such as PROFIT SUITE by HONEYWELL INTERNATIONAL INC. Each of the controllers and operator stations could also include at least one network interface, such as one or more Ethernet interfaces or wireless transceivers.

In many instances of an industrial process control and automation system, valuable legacy software (such as user-created software programs and object files, as well as control system operating system software) may outlive the availability of the processors or other hardware on which it was first targeted. Valuable legacy software may also be threatened by rising processor costs, particularly as processors become more expensive when supplies fall in the face of continuing long-term demand. In some cases, valuable legacy software may be re-hosted onto other processors via recompilation.

However, in other cases, recompilation is not a feasible option. For example, idiosyncrasies and customizations in the legacy software may have been put into place many years prior, and it could be prohibitively expensive to recreate that functionality in a current software engineering environment. Another common problem involves users having compiled object files in which desired functionality has been operating fully for a lengthy period of time, but the source code for the object files has been lost. Moving to a different system could therefore require substantial effort to recreate the desired functionality. The question therefore stands how to keep older legacy software useable on modern (and upgradeable) processors in light of the software's affinity for older processors or other hardware that, for the reasons described above, no longer make business sense.

Emulation of a processor and its surrounding hardware environment (such as peripherals, clock sources, and interrupt mechanisms) can support the unmodified execution of legacy software programs on new and modern hardware. Emulation can achieve bit-for-bit equivalence of machine operation for a set of machine instructions native to an older model computer on a newer, faster, and more available computer. No recompilation of the legacy software may be required. A full emulation includes more than just the sequential fetching and decoding of machine codes. Rather, a full emulation also involves methods for communication with peripheral I/O systems, handling of interrupts, and interaction with parts of the “whole legacy computer” that are outside of the processor itself. Examples of this are external clock subsystems, encryption devices, and serial ports used as debug channels.

In accordance with this disclosure, an emulation system and a translation system are provided and can be used separately or in combination to support the execution of legacy software using upgraded hardware components. These systems can be used to provide a framework by which interrupts may be properly handled, timers function properly, a rich debugging environment is supported, and peripheral I/O systems are well interfaced and operable by the legacy software. Such a system can be testable, and emulated/translated software running on new hardware can be demonstrably equivalent to the same software running on original hardware. If desired, performance can be constrained to be equivalent, meaning the emulated/translated software could operate neither slower nor faster than the original software runs on original equipment. Of course, this need not be the case, and in some instances the original software can execute faster than originally designed to provide improved performance.

To support this functionality, the process control and automation system 100 of FIG. 1 includes a conversion framework 144. The conversion framework 144 is communicatively linked to the network 136 in this example, although the conversion framework 144 could be linked to any other suitable network(s) in the system 100.

The conversion framework 144 is configured to convert at least a portion of a first software (such as a legacy software) to a second software (such as an INTEL x86 software). For example, the system 100 can be operating with one or more controllers 106a, which implement a first software to perform various process control operations. The conversion framework 144 can obtain the first software of the one or more controllers 106a from any suitable source and convert the software to a second software for the controller 106b. In some embodiments, the conversion framework 144 converts software using at least one of an emulation technique or a translation technique. The conversion framework 144 can also transmit converted software to the controller 106b so that the controller 106b can seamlessly perform the processes of the one or more controllers 106a.

It should be understood that while the above example illustrates converting software of controllers 106a-106b, the conversion framework 144 can convert the software of any component within the system 100. Other software could include software used by the sensors 102a, actuators 102b, switch/firewalls 110 and 118, routers/firewalls 126 and 134, controllers 114 and 122 and 130 and 138, operator stations 116 and 124 and 132 and 140, historian 142, or other components of the plants 101a-101n.

As a particular example of this functionality, one or more of the controllers 106a could be legacy controllers, such as Total Distributed Control (TDC) 3000 controllers from HONEYWELL INTERNATIONAL INC. The one or more controllers 106a can operate using legacy software, such as software written in the PASCAL programming language or the like. The legacy software can be executed using legacy processors, such as MOTOROLA 68040 processors or the like. The controller 106b could be a more advanced controller than the legacy controllers 106a and can include one or more advanced processors. The controller 106b could be installed into the system 100 in order to replace the one or more controllers 106a. The controller 106b operates using a different operating system from the operating system of the one or more controllers 106a. In some cases, the software of the one or more controllers 106a may be re-hosted onto other processors or components via a recompilation mechanism. Recompilation may not be feasible, however, such as for the reasons described above. In order for the controller 106b to replace the one or more controllers 106a and perform the processes of the one or more controllers 106a, new software is installed into the controller 106b as discussed below.

Although FIG. 1 illustrates one example of an industrial process control and automation system 100, various changes may be made to FIG. 1. For example, a control system could include any number of sensors, actuators, controllers, servers, operator stations, networks, and conversion frameworks. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, process control systems are highly configurable and can be configured in any suitable manner according to particular needs. In addition, while FIG. 1 illustrates one example environment in which a conversion framework can be used, this functionality can be used in any other suitable device or system.

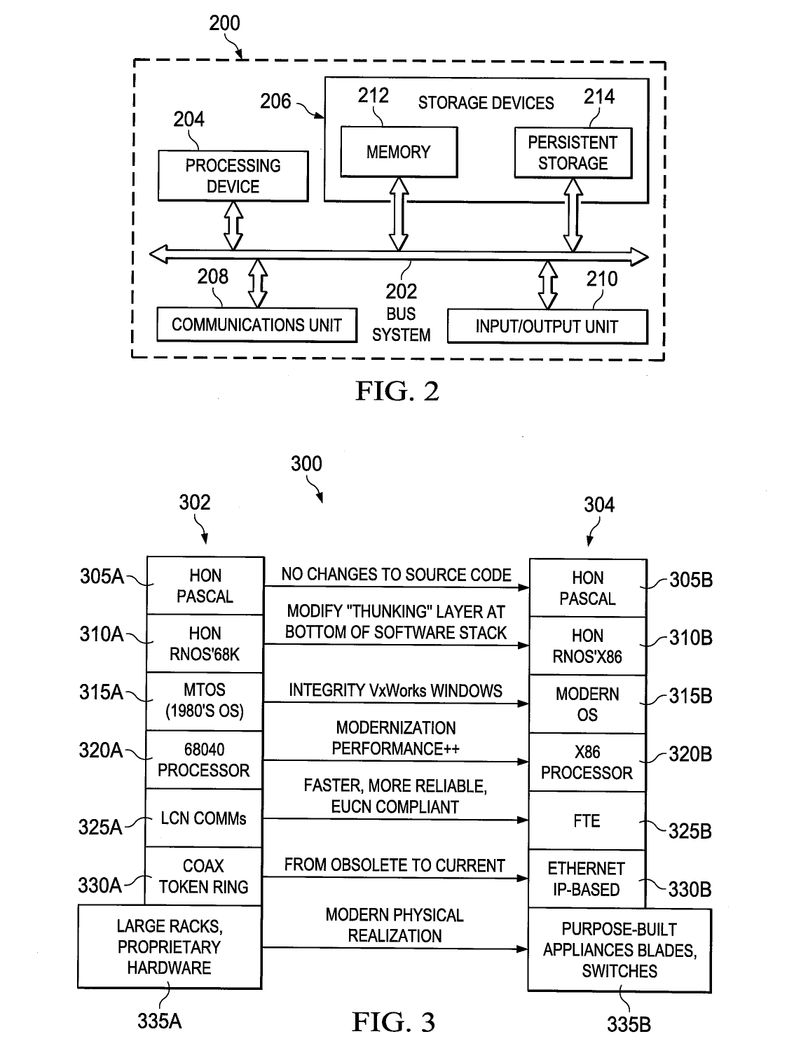

FIG. 2 illustrates an example device 200 for preserving the value and extending the life of legacy software according to this disclosure. The device 200 could, for example, be used to implement the conversion framework 144 in the system 100 of FIG. 1. Note, however, that the conversion framework 144 could be implemented in any other suitable manner and that the device 200 could be used in any other suitable system.

As shown in FIG. 2, the device 200 includes a bus system 202, which supports communication between at least one processing device 204, at least one storage device 206, at least one communications unit 208, and at least one input/output (I/O) unit 210. The processing device 204 executes instructions that may be loaded into a memory 212. The processing device 204 may include any suitable number(s) and type(s) of processors or other devices in any suitable arrangement. Example types of processing devices 204 include microprocessors, microcontrollers, digital signal processors, field programmable gate arrays, application specific integrated circuits, and discrete circuitry.

The memory 212 and a persistent storage 214 are examples of storage devices 206, which represent any structure(s) capable of storing and facilitating retrieval of information (such as data, program code, and/or other suitable information on a temporary or permanent basis). The memory 212 may represent a random access memory or any other suitable volatile or non-volatile storage device(s). The persistent storage 214 may contain one or more components or devices supporting longer-term storage of data, such as a read only memory, hard drive, Flash memory, or optical disc. In some embodiments, the storage devices 206 can be configured to store converted software so that the processing device 204 is able to execute tests of the converted software and ensure that the converted software is running demonstrably the same as original software.

The communications unit 208 supports communications with other systems or devices. For example, the communications unit 208 could include a network interface card or a wireless transceiver facilitating communications over a network. The communications unit 208 may support communications through any suitable physical or wireless communication link(s).

The I/O unit 210 allows for input and output of data. For example, the I/O unit 210 may provide a connection for user input through a keyboard, mouse, keypad, touchscreen, or other suitable input device. The I/O unit 210 may also send output to a display, printer, or other suitable output device.

The processing device 204 is configured to convert at least a portion of a first software into a second software. In some embodiments, the processing device 204 can determine whether to convert the first software using a translation technique or an emulation technique. The determination whether to convert the first software using the translation technique or the emulation technique can occur in any suitable manner. For example, the processing device 204 could examine the first software and identify the most appropriate technique to be used. In other embodiments, the decision can be made ahead of time manually, such as by engineers or other personnel on a case-by-case basis, and the processing device 204 can identify the appropriate technique to be used for each software based on a flag or other indicator. A translation technique includes translating lines of the first software program in a first programming language into equivalent lines of a second software program in a second programming language. An emulation technique includes executing a first software program written in a first programming language, determining the functions performed by the first software program, and generating a second software program written in a second programming language that performs the same functions as the first software program.

Note that both the translation technique and the emulation technique could be used with the same original software, such as when the more appropriate technique is selected and used for individual portions or functions of the original software. For example, I/O functions of the original software could be supported using emulation, while numerical computations of the original software could be subjected to translation. Both forms of execution (emulation and translation) can alternate operations through mechanisms built into the conversion framework 144 that allows the emulation framework to support calling of translated code from the emulation system and that allows the translation system to support calling of emulated code from the translation system.

In some embodiments, the determination whether to convert at least part of the first software using the translation technique and/or the emulation technique can be based on whether the first software utilizes off-CPU board functions (such as clock subsystems, debug ports, or the like) or I/O devices (such as a keyboard, mouse, video I/O device, disk drive, networking device, or the like). If so, a translation technique can be used to convert at least part of the first software. If not, an emulation technique can be used to convert at least part of the first software. The emulation technique can also be used to convert at least part of the first software when the first software includes certain functions, such as 68040 CPU instruction execution including exception processing.

As discussed in the example above, the one or more controllers 106a could implement a first software to perform industrial process control operations. The processing device 204 can obtain the first software of the one or more controllers 106a and convert the obtained software to the second software for the controller 106b. The processing device 204 can convert the first software to the second software using the emulation technique and/or the translation technique. The processing device 204 also stores the second software in a storage device 206. The processing device 204 can use the storage device 206 as an execution environment to execute the second software to determine whether the second software performs the same operations as the first software. The processing device 204 can also transmit the second software to the controller 106b so that the controller 106b can seamlessly perform the operations of the one or more controllers 106a.

Although FIG. 2 illustrates one example of a device 200 for preserving the value and extending the life of legacy software, various changes may be made to FIG. 2. For example, various components in FIG. 2 could be combined, further subdivided, or omitted and additional components could be added according to particular needs. Also, computing devices can come in a wide variety of configurations, and FIG. 2 does not limit this disclosure to any particular configuration of computing device.

FIG. 3 illustrates an example translation 300 for preserving the value and extending the life of legacy software according to this disclosure. As shown in FIG. 3, an architecture 302 denotes a legacy controller, while an architecture 304 denotes an updated or newer controller. The architecture 302 includes software code 305A, which in this example is implemented using PASCAL. The software code 305A could include millions of lines of coded functionality. The architecture 302 also includes a legacy real-time networked operating system (RNOS) 310A running on top of a legacy operating system (MTOS) 315A. These components are executed on a legacy processor 320A, such as a MOTOROLA 68040 processor. A local control network (LCN) driver 325A and a coaxial physical interface 330A are used to support communications over a legacy network. Finally, hardware 335A of the controller includes large racks of industrial equipment with large amounts of proprietary hardware.

The architecture 304 includes software code 305B, which can represent the same code as the software code 305A. No changes may need to be made to the software code 305A, except the software code 305A could be recompiled for use on a newer hardware platform. The architecture 304 also includes an updated RNOS 310B running on top of an updated operating system (OS) 315B. These components are executed on a newer processor 320B, such as an INTEL x86 processor. An FTE driver 325B and an Ethernet-based physical interface 330B are used to support communications over a modern network. Finally, hardware 335B of the controller includes purpose-built appliances, blades, and switches.

During a conversion of software used by the architecture 302 to software for use by the architecture 304, the actual source code 305A itself can remain unchanged and be used as the source code 305B. The conversion framework 144 can instead operate to modify various lower levels of the software stack to facilitate execution of the source code 305B on the new hardware platform.

In some embodiments in which an EXPERION LOCAL CONTROL NETWORK (ELCN) software architecture from HONEYWELL is used, existing “customer created” TDC data objects (such as checkpoints, button configuration files, display objects, CL/AM objects, and the like) can run without recompilation, rebuilding, or reconstruction. Also, for any given “customer created” TDC data object source file, there may be one compiled object file. Additionally, customer experience on similar node types of differing architectures can be the same. All data on a network wire can be in the same format supporting hybrid coaxial LCN and ELCN topology communications, and all data on a mass storage can be in the same format supporting consistent data internally and externally to the ELCN.

Although FIG. 3 illustrates one example of a translation 300 for preserving the value and extending the life of legacy software, various changes may be made to FIG. 3. For example, various components in FIG. 3 could be combined, further subdivided, or omitted and additional components could be added according to particular needs. Also, while FIG. 3 illustrates one specific example of a translation, any other suitable translations involving different architectures could also be supported.

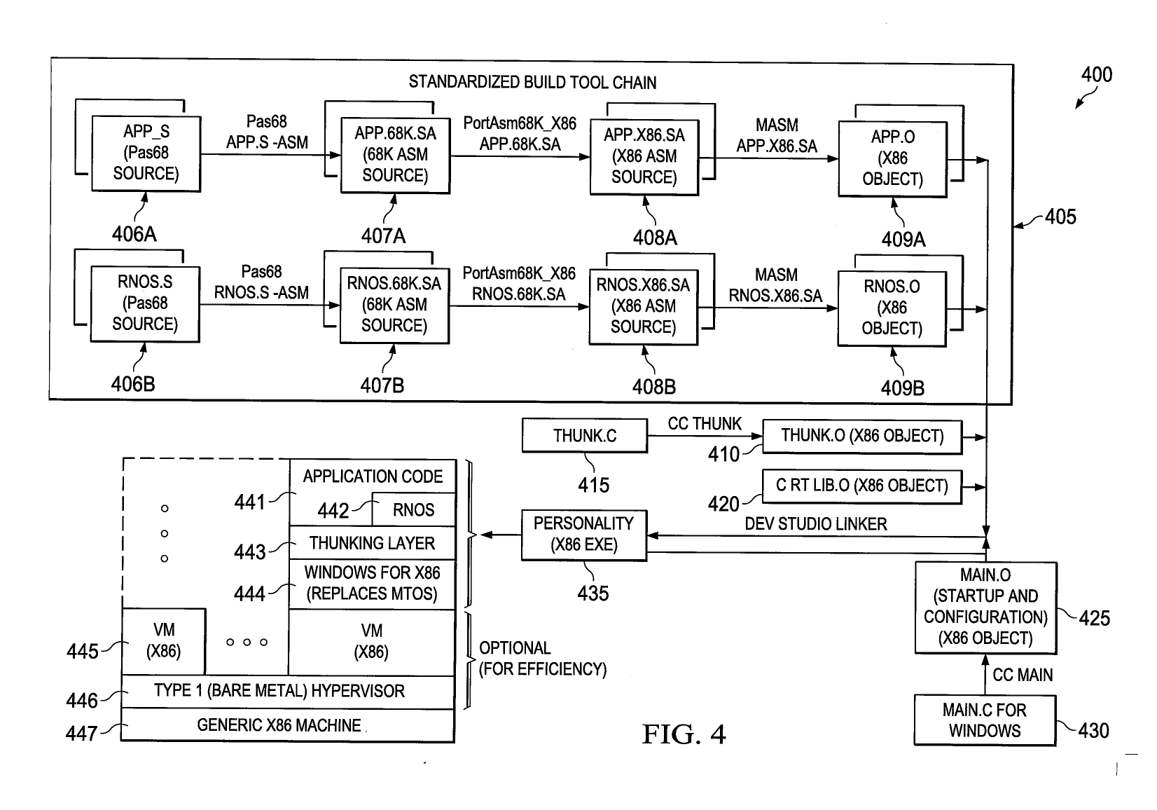

FIG. 4 illustrates an example conversion architecture 400 to implement a software translation according to this disclosure. The conversion architecture 400 shown in FIG. 4 could, for example, be implemented within the conversion framework 144 of FIG. 1 to support translations such as the one shown in FIG. 3. Note, however, that the conversion framework 144 could be implemented in any other suitable manner and that the conversion architecture 400 could be used in any other suitable system.

As shown in FIG. 4, the architecture 400 includes a standardized build tool chain 405, which includes multiple processes that can run in parallel (although this need not be the case). One process includes operations involving the underlying software source code being converted, while another process includes operations involving the RNOS being converted.

Taking the first process as an example, original source code 406A (PASCAL code in this example) is converted into assembly language (ASM) code 407A, which is suitable for execution on a legacy processor (a 68040 processor in this example). The ASM code 407A is then converted into ASM code 408A, which is suitable for execution on a newer processor (an x86 processor in this example). Finally, the ASM code 408A is converted into object (machine) code 409A, which essentially represents the original source code 406A recompiled and prepared for execution on the newer processor. Each operation performed in the first process can occur using any suitable software tools. For instance, a standard compiler can be used to convert the source code 406A into the ASM code 407A, a standard converter can be used to convert the ASM code 407A into the ASM code 408A, and a standard assembler can be used to convert the ASM code 408A into the object code 409A. The second process similarly converts RNOS original source code 406B into ASM code 407B, which is converted into ASM code 408B and then converted into object code 409B.

A linker uses the object codes 409A-409B, thunk object code 410 (generated using source code 415), library object code 420, and main object code 425 (generated using source code 430) to generate an executable file 435. The executable file 435 denotes the software that is able to execute on a newer or more updated hardware platform. The executable file 435 includes application code 441, RNOS code 442, a thunking layer 443, and an OS layer 444 (WINDOWS in this example). The executable file 435 can optionally be executed using one or more virtual machines (VMs) 445, which can optionally run on top a hypervisor 446. These components are executed by an x86 computing device 447 in this example.

Although FIG. 4 illustrates one example of a conversion architecture 400 to implement a software translation, various changes may be made to FIG. 4. For example, various components in FIG. 4 could be combined, further subdivided, or omitted and additional components could be added according to particular needs. Also, while FIG. 4 illustrates one specific translation involving PASCAL code executing on an 68040 processor to code executing on an x86 processor, any other suitable translations involving different architectures could also be supported.

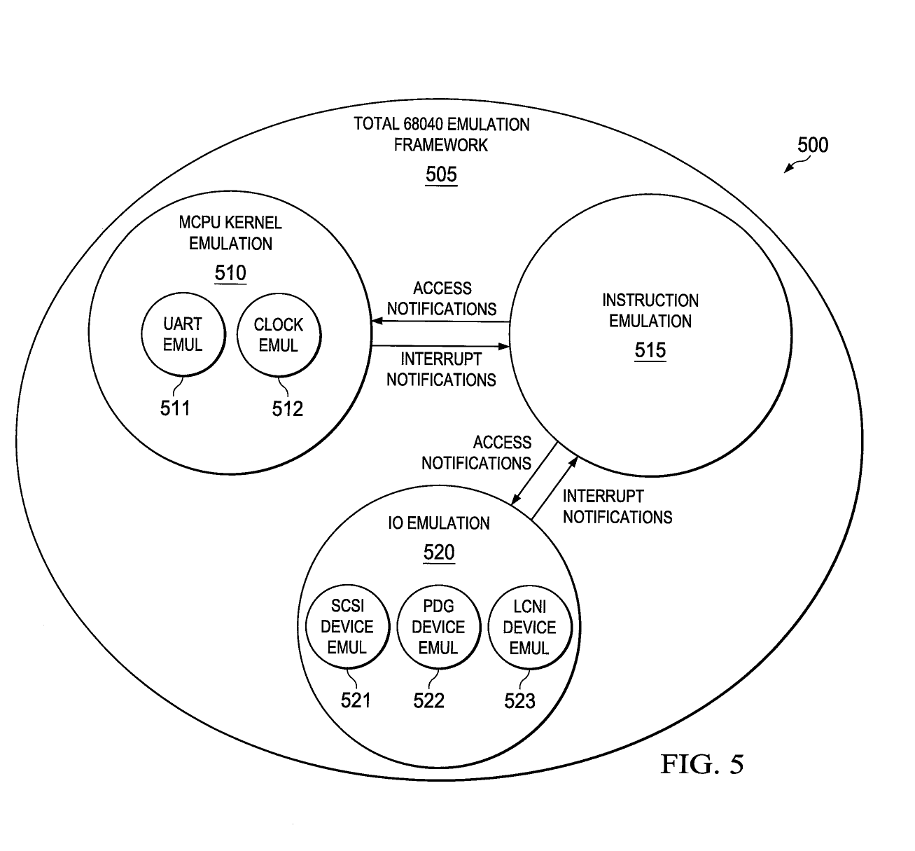

FIG. 5 illustrates an example emulation architecture 500 according to this disclosure. The emulation architecture 500 shown in FIG. 5 could, for example, be implemented within the conversion framework 144 of FIG. 1. Note, however, that the conversion framework 144 could be implemented in any other suitable manner and that the emulation architecture 500 could be used in any other suitable system.

As shown in FIG. 5, the emulation architecture 500 includes an emulation framework 505, which is used to emulate a specific type of processor (a 68040 processor in this example) on another type of processor (such as an x86 processor). The framework 505 includes a kernel emulator 510, an instruction emulator 515, and an I/O emulator 520. As the names imply, the kernel emulator 510 is used to emulate so-called kernel functions (compute functions not typically performed by a main processor, examples of which are named below). Also, the instruction emulator 515 is used to emulate the execution of instructions on a processor, and the I/O emulator 520 is used to emulate input and output operations on a processor.

The kernel emulator 510 in this example includes a universal asynchronous receiver/transmitter (UART) emulator 511 and a clock emulator 512. The UART emulator 511 is used to emulate a UART interface of the 68040 processor, while the clock emulator 511 is used to emulate a clock source of the 68040 processor. The use of the clock emulator 511 allows software to be executed using the emulation framework 505 at a similar speed as the original software on the 68040 processor.

The instruction emulator 515 is used to implement various instructions that are not executed within the kernel emulator 510. For example, the instruction emulator 515 can be used to execute the various instructions in legacy source code in order to emulate the execution of the legacy source code on the 68040 processor. In some embodiments, the instruction emulator 515 could denote an instruction emulator from MICROAPL LTD. In specific embodiments, the instruction emulator 515 could include various features to support the emulation functionality. For instance, the instruction emulator 515 could support the handling of unusual addressing modes, such as 26 bits rather than the typical 8, 16, 24, and 32 bits. The instruction emulator 515 could also support the handling of a “stack indicator” bit at the top of each address and the handling of casts (“LOOPHOLE” in PASCAL) in order to remap addresses as necessary. In addition, the instruction emulator 515 could support the handling of all data in a particular format, such as “big endian,” regardless of the processor architecture (big endian or little endian).

The I/O emulator 520 in this example includes a small computer system interface (SCSI) device emulator 521, a HONEYWELL PDG video device emulator 522, and a local control network interface (LCNI) emulator 523. These emulators 521-523 are used to emulate different types of input and output interfaces often used with the 68040 processor.

The emulators 510, 515, and 520 communicate and exchange access notifications and interrupt notifications. An access notification is used to indicate that one emulator needs to access data or other information associated with another emulator. An interrupt notification is used by one emulator to inform another emulator that an interrupt has occurred so that the other emulator can take suitable action in response to the interrupt.

Although FIG. 5 illustrates one example of an emulation architecture 500, various changes may be made to FIG. 5. For example, various components in FIG. 5 could be combined, further subdivided, or omitted and additional components could be added according to particular needs. Also, while FIG. 5 illustrates one specific emulation involving an 68040 processor, any other suitable emulations involving different processors could also be supported.

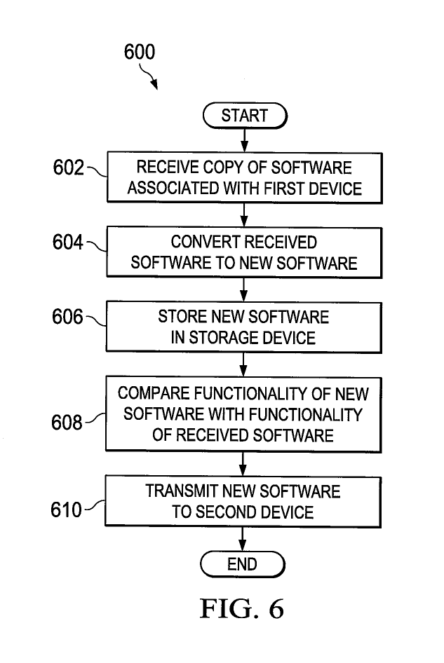

FIG. 6 illustrates an example method 600 for preserving the value and extending the life of legacy software according to this disclosure. For ease of explanation, the method 600 is described as being performed by the conversion framework 144 in FIG. 1 implemented as shown in FIG. 2. However, the method 600 could be performed using any suitable device and in any suitable system.

As shown in FIG. 6, a copy of software associated with a first device is obtained at step 602. This could include, for example, the processing device 204 of the conversion framework 144 obtaining a copy of software executed by a first device (such as a process controller) from the first device or from another source.

At least part of the software is converted into new software at step 604. This could include, for example, the processing device 204 of the conversion framework 144 determining whether to use a translation technique and/or an emulation technique to generate the new software. As noted above, the processing device 204 could identify which technique to use itself or identify the technique that was selected manually by engineers or other users. If the translation technique is used, the processing device 204 of the conversion framework 144 could implement the technique shown in FIG. 4 to convert the original software into new software. If the emulation technique is used, the processing device 204 of the conversion framework 144 could implement the technique shown in FIG. 5 to convert the original software into new software. Also as noted above, different portions of the original software could undergo translation and emulation. The selection of whether to use translation or emulation can be based on which technique is more appropriate for the functions in the different portions of the original software (such as emulation for I/O and translation for numerical computations). The new software is configured to perform the same functions as the original software, but a programming language of the new software is different from a programming language of the original software, and the original and new software can be executed on different operating systems.

The new software is stored at step 606, and the functionality of the new software is compared to the functionality of the received software at step 608. This could include, for example, the processing device 204 of the conversion framework 144 determining whether the new software performs the same functions as the original software. If so, at some point the new software can be provided to a new device at step 610. This could include, for example, the conversion framework 144 or another device retrieving the new software from memory and providing the new software to the new device for execution.

Although FIG. 6 illustrates one example of a method 600 for preserving the value and extending the life of legacy software, various changes may be made to FIG. 6. For example, while shown as a series of steps, various steps shown in FIG. 6 could overlap, occur in parallel, occur in a different order, or occur multiple times. Moreover, some steps could be combined or removed and additional steps could be added according to particular needs.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining a copy of a first software executed by a first device in an industrial process control and automation system;
converting the first software to a second software, the second software configured to perform functions of the first software, a programming language of the second software different from a programming language of the first software, the first and second software designed for use with different operating systems; and
providing the second software to a second device in the industrial process control and automation system for execution.

2. The method of claim 1, wherein converting the first software to the second software comprises determining whether to implement at least one of an emulation technique and a translation technique.

3. The method of claim 2, wherein the translation technique is used for at least a portion of the first software when the converting does not include off-central processing unit board functions or functions for input/output devices.

4. The method of claim 2, wherein the emulation technique is used for at least a portion of the first software when the converting includes converting central processing unit execution instructions.

5. The method of claim 2, wherein the emulation technique provides a framework for the second software to implement at least one of an interrupt, a timer, debugging, and a peripheral input/output system interaction operation of the first software.

6. The method of claim 2, wherein:
the translation technique is used for portions of the first software involving numerical computations; and
the emulation technique is used for portions of the first software involving input/output functions.

7. The method of claim 1, further comprising:
comparing functionality of the second software with functionality of the first software to determine whether the second software performs the same functions of the first software.

8. The method of claim 1, wherein the first and second devices comprise process controllers in the industrial process control and automation system, each process controller configured to control at least a portion of one or more industrial processes, the first device comprising a legacy process controller, the second device comprising a new or updated process controller.

9. An apparatus comprising:
at least one memory configured to store a copy of a first software executed by a first device in an industrial process control and automation system;
at least one processing device configured to convert the first software to a second software, the second software configured to perform functions of the first software, a programming language of the second software different from a programming language of the first software, the first and second software designed for use with different operating systems; and
at least one interface configured to provide the second software to a second device in the industrial process control and automation system for execution.

10. The apparatus of claim 9, wherein the at least one processing device is configured to convert the first software to the second software by determining whether to implement at least one of an emulation technique and a translation technique.

11. The apparatus of claim 10, wherein the translation technique is used when the converting does not include off-central processing unit board functions or functions for input/output devices.

12. The apparatus of claim 10, wherein the emulation technique is used when the converting includes converting central processing unit execution instructions.

13. The apparatus of claim 10, wherein the emulation technique provides a framework for the second software to implement at least one of an interrupt, a timer, debugging, and a peripheral input/output system interaction operation of the first software.

14. The apparatus of claim 9, wherein:
the translation technique is used for portions of the first software involving numerical computations; and
the emulation technique is used for portions of the first software involving input/output functions.

15. The apparatus of claim 9, wherein the at least one processing device is configured to compare functionality of the second software with functionality of the first software to determine whether the second software performs the same functions of the first software.

16. A non-transitory computer readable medium containing instructions that, when executed by at least one processing device, cause the at least one processing device to:
obtain a copy of a first software executed by a first device in an industrial process control and automation system;
convert the first software to a second software, the second software configured to perform functions of the first software, a programming language of the second software different from a programming language of the first software, the first and second software designed for use with different operating systems; and
provide the second software to a second device in the industrial process control and automation system for execution.

17. The non-transitory computer readable medium of claim 16, further containing instructions that, when executed by the at least one processing device, cause the at least one processing device to determine whether to implement at least one of an emulation technique and a translation technique in order to convert the first software to the second software.

18. The non-transitory computer readable medium of claim 17, wherein the translation technique is used when the converting does not include off-central processing unit board functions or functions for input/output devices.

19. The non-transitory computer readable medium of claim 17, wherein the emulation technique is used when the converting includes converting central processing unit execution instructions.

20. The non-transitory computer readable medium of claim 16, further containing instructions that, when executed by the at least one processing device, cause the at least one processing device to compare functionality of the second software with functionality of the first software to determine whether the second software performs the same functions of the first software.
